(19) United States
(12) Patent Application Publication
(10) Pub. No.: US 2008/0013428 A1
(43) Pub. Date: Jan. 17, 2008

(54) Servo System, Record Carrier and Playback Device

(75) Inventor: Josephus Arnoldus Henricus Maria Kahlman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,718

(22) PCT Filed: May 4, 2005
(86) PCT No.: PCT/IB05/51460

§ 371 Date: Nov. 6, 2006

(30) Foreign Application Priority Data
May 12, 2004 (EP) 04102065.2

(51) Int. Cl. G11B 7/00

(52) U.S. Cl. 369/53.28

(57) ABSTRACT

To improve the performance of a servo system, used for tracking a track on a record carrier, the bandwidth of the servo system must be adjusted. Instead of injecting a signal into the servo system to allow adjustment of the bandwidth, the track position modulation of the record carrier is used. The track position modulation comprises two signals of which the signal with the lower frequency has a higher amplitude than the signal with the higher frequency. After the reduction by the servo system the second signal is used as a reference and optimal adjustment of the bandwidth can be achieved.

The invention relates to a servo system for radial tracking of an optical spot on a record carrier having an adjustable bandwidth and a device for adjusting the adjustable bandwidth by processing a first signal with a first frequency and to playback device comprising a servo system and a record carrier comprising a track position modulation with a first frequency and a first amplitude.

Such a servo system is known from U.S. Pat. No. 4,482,989 where a signal is injected into the servo system to adjust the gain and consequently also the bandwidth of the servo system. Such a servo system has the disadvantage that the servo system still cannot properly adjust the bandwidth based on the injected signal because the injected does not represent the actual signals to be processed by the servo system accurately enough. Thus the bandwidth of the servo system is not optimally to the actual record carrier on which the servo system must perform the tracking.

It is the object of the invention to provide a servo system that allows an optimal adjustment to the actual record carrier on which the servo system must perform the tracking.

This object is achieved by a servo system that is characterized in that that the device is arranged to utilize a difference between a value representing a parameter of the first signal as derived from the record carrier and a further value representing the same parameter of a second signal with a second frequency derived from the same record carrier for adjusting the adjustable bandwidth.

By using two signals one signal can be used as a reference while the other can be used to adjust the bandwidth. In addition by using signals derived from the record carrier itself all variations caused by the read-out of the record carrier, such as variations in the rotational speed of the record carrier or variations in the read-out path of the playback device, have no longer an influence on the optimal adjustment of the bandwidth since these variations are taken into account by deriving the two signals from the record carrier instead of from an injected signal that is not directly related to the record carrier. This allows a more flexible adaptation of the servo loop to differences in the various standards for record carriers such as CD, DVD or Blu-disc.

Thus by using two signals with a different value of the same parameter derived from the record carrier the servo system can adjust the bandwidth such that the two signals, having different frequencies, are subject to different reductions introduced by the servo system since the reduction introduced by the servo system is frequency dependent.

An embodiment of the servo system for radial tracking of an optical spot on a record carrier is characterized in that the first signal is within the adjustable bandwidth and the second signal is outside the adjustable bandwidth of the servo system while tracking with an adjusted bandwidth.

By positioning the bandwidth during tracking such that the first signal is within the adjustable bandwidth and the second signal is outside the adjustable bandwidth the tracking of the control system is optimized. The first signal is affected by a reduction as a result of the servo system performing the tracking, i.e. keeping the optimal tracking and the actual tracking error as small as possible. The second signal is outside the bandwidth of the servo system. The servo system consequently is not able to track the second signal, resulting in a minimal reduction. The second signal can thus function as a reference signal to which properties of the first signal can be compared.

A further embodiment of the servo system for radial tracking of an optical spot on a record carrier is characterized in that the first frequency is lower than the second frequency.

Since most tracking systems have a bandwidth with a low pass characteristic it is advantageous to position the first signal in the low pass band and the second signal at a higher frequency outside the low pass band.

A further embodiment of the servo system for radial tracking of an optical spot on a record carrier is characterized in that the device for adjusting the bandwidth is arranged to adjust the bandwidth such that the further value when corrected for a first reduction by the servo system is lower than the value when corrected for a second reduction by the servo system.

Both signals are derived from the record carrier. The servo system can thus adjust its bandwidth based on the known input signal comprising the first and second signal. The reduction is frequency dependent and knowing the reductions introduced by the servo system at various frequencies the servo system can adjust its bandwidth such that the value of the parameter of the first and second signal when corrected for the known reductions at the respective frequencies correspond to the actual values of the parameter of the first and second signal on the record carrier. When the servo system adjusts the bandwidth until the value of the parameters of the first and second signal when corrected for the known reductions at the respective frequencies correspond to the actual values of the parameters of the first and second signal on the record carrier optimal adjustment of the bandwidth is achieved.

The resulting signal with the highest value, for instance amplitude, determines the tracking performance of the servo system.

A further embodiment of the servo system for radial tracking of an optical spot on a record carrier is characterized in that the further value corrected for the first reduction by the servo system and the value when corrected for the second reduction by the servo system have a ratio within a predetermined range.

By using two signals with values with a predetermined ratio it is easy to verify the correctness of the value using the further value as a reference.

A further embodiment of the servo system for radial tracking of an optical spot on a record carrier is characterized in that the servo system comprises retrieval means for retrieving information from the record carrier indicating the value and the further value. This allows the servo system to work with many different signals, i.e. the frequency, amplitude or other parameters of the signals need no longer be predefined and identical from record carrier to record carrier but can vary from batch of record carriers to batch of record carriers, or from manufacturer to manufacturer. This results in a more adaptable servo system that can perform optimal tracking on record carriers from many sources.

A further embodiment of the servo system for radial tracking of an optical spot on a record carrier is characterized in that the parameter is an amplitude of the signal.

The amplitude of the first and second signal can be easily retrieved, corrected for the reduction and compared by the servo system. The adjustment of the bandwidth can be performed by taking into consideration the effects of the reduction on the amplitude of the first and second signal and adjusting the bandwidth until the desired amplitude relation first and second resulting signals, i.e. the first and second signal after reduction by the servo system, is obtained.

A further embodiment of the servo system for radial tracking of an optical spot on a record carrier is characterized in that the parameter is a phase of the signal. The phase of the first and second signal can be easily retrieved, corrected for the reduction and compared by the servo system. The adjustment of the bandwidth can be performed by taking into consideration the effects of the reduction on the phase of the first and second signal and adjusting the bandwidth until the desired phase relation between the first and second resulting signals is obtained.

A further embodiment of the servo system for radial tracking of an optical spot on a record carrier is characterized in that the first signal and the second signal are signal components of a single signal.

A single signal can provide two signal components such as a first harmonic and a second harmonic. The two components can then be used as the first signal and the second signal. A precise phase and amplitude relationship can be achieved this way because the signal waveform determines the phase and amplitude relationships.

A further embodiment of the servo system for radial tracking of an optical spot on a record carrier is characterized in that the single signal is a square wave signal. A square wave signal comprises many components, i.e. harmonics, that can be used as the first and the second signal. For instance the first harmonic component can be used as the first signal and one of the higher harmonics can be used as the second signal.

Since the square wave has many harmonics the servo system can select the optimum harmonics to operate on. When the rotational speed of the record carrier varies the servo system can select different sets of harmonics to adjust the adjustable bandwidth.

The values can be stored on the record carrier for various harmonics so that the system can select and operate on the optimum pair of harmonics.

A further embodiment of the servo system for radial tracking of an optical spot on a record carrier is characterized in that servo system comprises a push pull detector for detecting the first signal and the second signal.

A push pull detector is part of many servo systems and can be used to derive the information relating to the first and second signal.

A further embodiment of the servo system for radial tracking of an optical spot on a record carrier is characterized in that servo system comprises a differential phase detector for detecting the first signal and the second signal.

A differential phase detector is part of many servo systems and can be used to derive the information relating to the first and second signal.

A further embodiment of the servo system for radial tracking of an optical spot on a record carrier is characterized in that the first servo signal and the second servo signal are utilized in an alternating fashion.

It is not required to have both the first and the second signal present at the same time. A single track position can be modulated alternating with the first signal and the second signal. Two subsequent sections of servo signals, each representing either the first signal or the second signal can be used to adjust the adjustable bandwidth since the adjustable bandwidth does not vary much once adjusted and is subject only to slow variations. There fore the slight delay introduced by the alternation does not result in unacceptable delays but provides adequate information for adjusting the bandwidth.

A playback device comprising a servo system achieves the object of the invention.

A playback device according to the invention benefits from the servo system because the better tracking results in a better playback of record carriers.

A further embodiment of the playback device is characterized in that the playback device further comprises a content ownership management device coupled to an output of the servo system and that the content ownership management device is arranged to receive information determined by the servo system based on the difference between the amplitude of the first signal and the amplitude of the second signal. Information about the amplitude can be stored on the record carrier in encrypted form.

Since the servo signals are difficult to duplicate due to their physical nature and the precisely defined relationship the information as used for the servo system can also be used for the content ownership management because a duplication of the record carrier will result in a disturbance of the phase or amplitude relationship between the first signal and the second signal. Such a disturbance can be detected and can be used to identify a record carrier as an original or a duplicate record carrier.

A record carrier according to the invention is characterized in that that the record carrier further comprises a second track position modulation with a second amplitude where the first frequency is lower than the second frequency and where the second amplitude is lower than the first amplitude.

By increasing the amplitude of the first signal the reduction, as introduced by the tracking of the servo system, is compensated and a first signal of suitable amplitude is available for a servo system of the playback device to work with, resulting in a enhanced adjustment of the adjustable bandwidth of the servo system and consequently an improved tracking adaptation of the servo system.

A further embodiment of the record carrier is characterized in that the first track position modulation and the second track position modulation are present in an alternating fashion.

It is not required to have both the first and the second signal present at the same time. A single track position can be modulated alternating with the first signal and the second signal. Two subsequent sections of servo signals, each representing either the first signal or the second signal can be used to adjust the adjustable bandwidth since the adjustable bandwidth does not vary much once adjusted. There fore the slight delay introduced by the alternation does not result in unacceptable delays but provides adequate information to the servo system for adjusting the bandwidth.

A further embodiment of the record carrier is characterized in that the record carrier comprises a first field storing a first parameter of the first signal and a second field storing a second parameter of the second signal.

The invention will now be described based on figures.

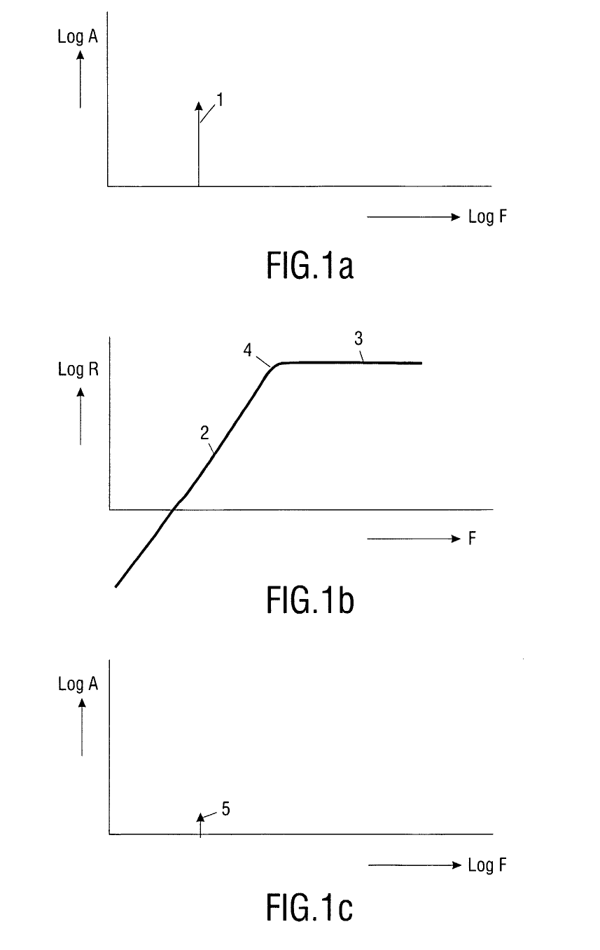

FIG. 1 shows the relation between a signal injected into the servo system, the reduction by the servo system and the result of the reduction.

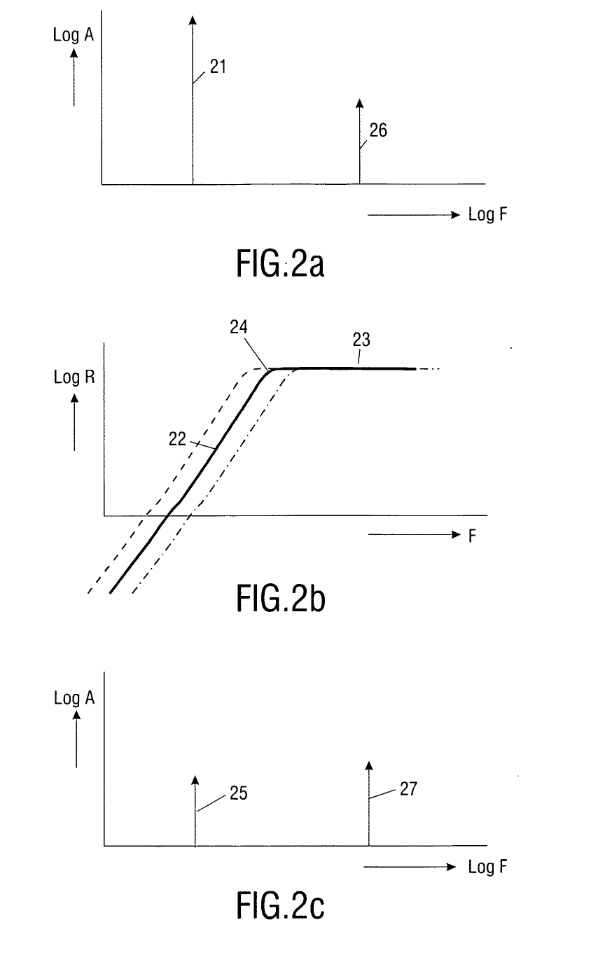

FIG. 2 shows the effect of the reduction by the servo system on track position modulation comprising two signals, one inside the bandwidth and one outside the bandwidth of the servo system.

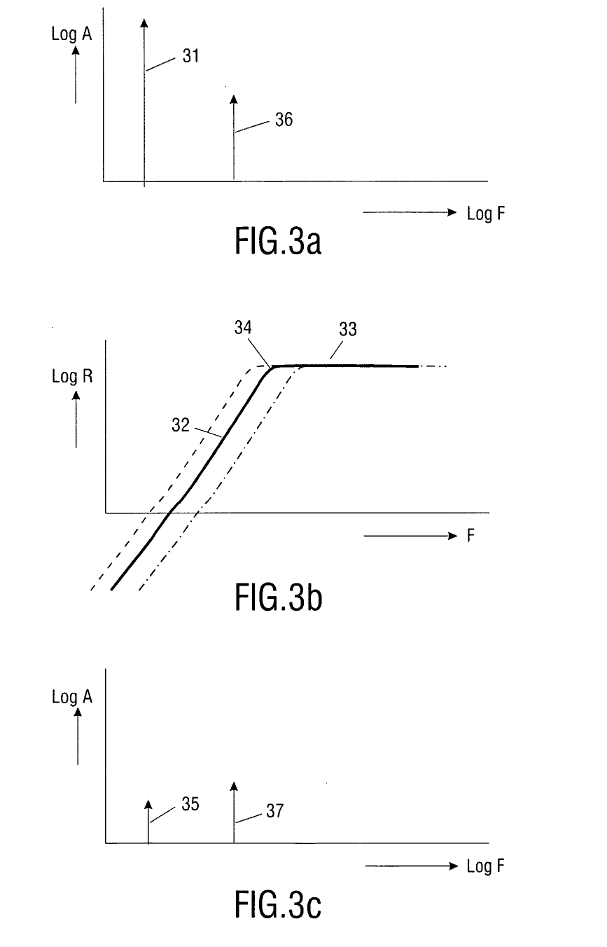

FIG. 3 shows the effect of the reduction by the servo system on track position modulation comprising two signals, both inside the bandwidth of the servo system.

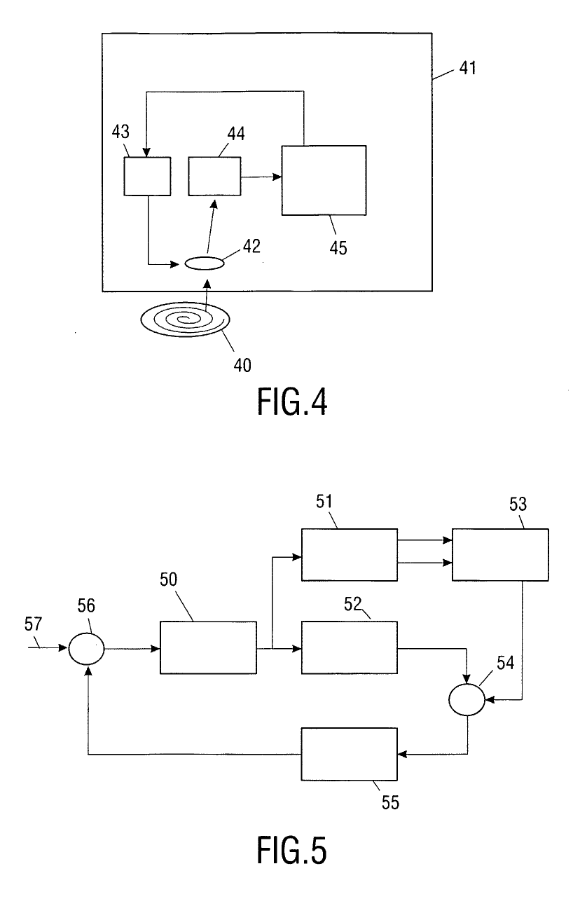

FIG. 4 shows a device comprising the servo system according to the invention

FIG. 5 shows a servo system with PP tracking and PP detection

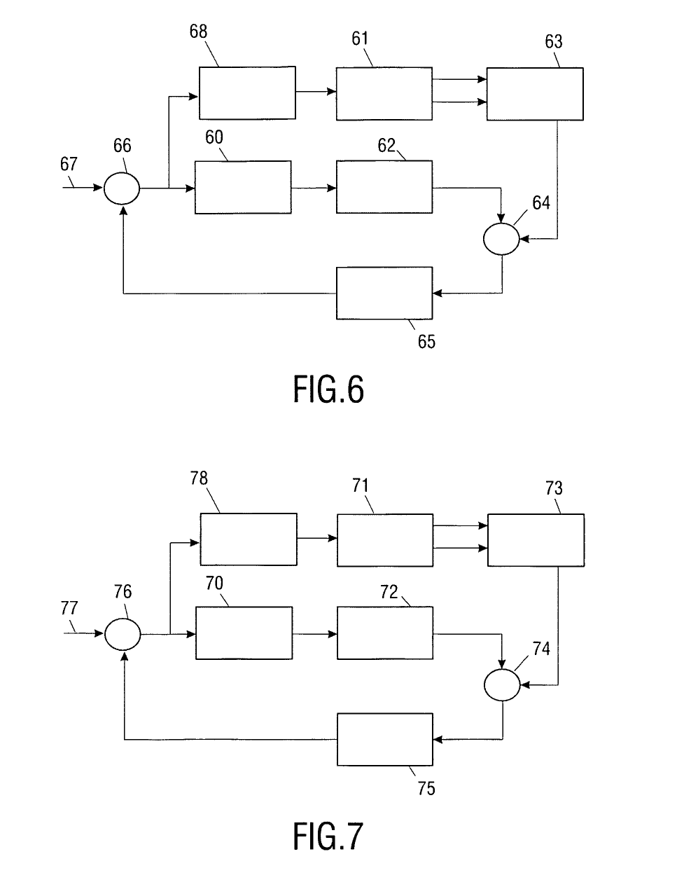

FIG. 6 shows a servo system with DPD tracking and PP detection

FIG. 7 shows a servo system with PP tracking and DPD detection

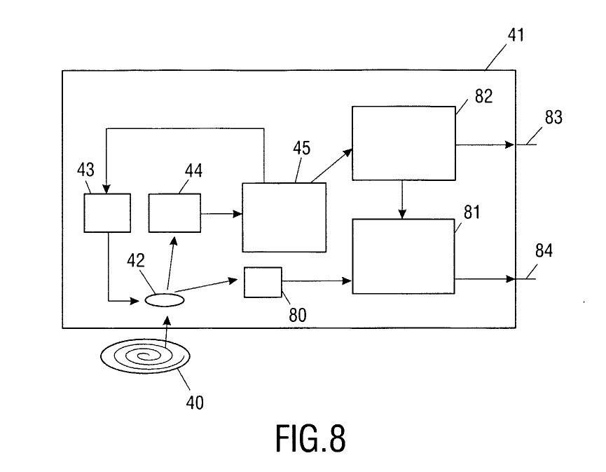

FIG. 8 shows a device using the servo system in a content ownership management system.

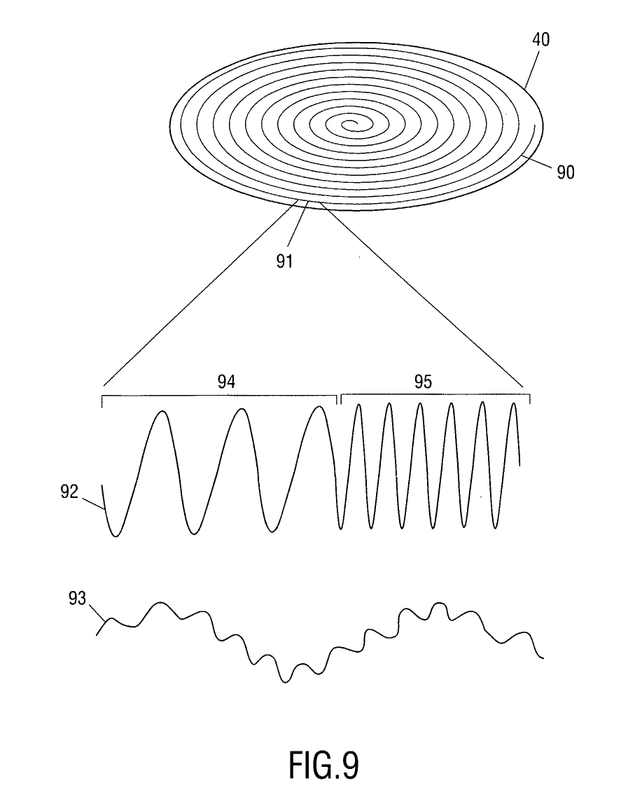

FIG. 9 shows a record carrier with two track position modulations

FIG. 1 shows the relation between a signal injected into the servo system, the reduction by the servo system and the result of the reduction and comprises three subfigures.

FIG. 1a shows the single signal 1 as is injected into the servo system to adjust the bandwidth of the servo system. The amplitude of the injected signal 1 is reduced by the reduction of the servo system. The reduction is a result of the control loop of the servo system which strives to achieve optimal tracking i.e. an error signal that is as small as possible. The injected signal 1 is perceived as an error signal and the control loop of the servo signal tries to suppress the injected signal 1. The injected signal 1 is used as a reference.

FIG. 1b shows the reduction by the servo system. The reduction is frequency dependent.

Within the bandwidth of the servo system the reduction is, in a log-log graph, a straight sloping line 2. The-frequency of the injected signal lies within the bandwidth.

By adjusting the gain of the servo system, which corresponds to a shift up or down of the straight sloping line section 2 of the reduction curve, the servo system is adjusted to obtain a desired response to the injected signal. The horizontal line section 3 lies outside the bandwidth of the servo system and represents a reduction of essentially zero dB.

When the entire graph is shifted up or down the straight sloping line section 2 effectively also moves to left or right and the intersection 4 with the horizontal line section 3 of the graph, which remains at a constant level, also moves left or right. Thus the bandwidth as indicated by the intersection 4 between the straight sloping line section 2 and the horizontal line section 3 is increased by a increase of the gain and decreased by an decrease of the gain.

FIG. 1c shows the effect of the reduction on the injected signal. The amplitude of the resulting signal 5 is quite small compared to the natural disturbances in the servo loop. This is undesirable in a servo system.

FIG. 2 shows the effect of the reduction by the servo system on track position modulation comprising two signals, one inside the bandwidth and one outside the bandwidth of the servo system.

FIG. 2a shows the two signals 21, 26 representing the track position modulations as present on the record carrier. The amplitude of the two signals 21, 26 is reduced by the reduction of the servo system. The reduction is a result of the control loop of the servo system which strives to achieve optimal tracking i.e. an error signal that is as small as possible. The modulation of the track position is perceived as an error signal and the control loop of the servo signal tries to suppress the modulation by adjusting the position of the optical pickup or magnetic head so that the optical pickup or magnetic head follows the track. The first signal 21 of the track modulation is within the bandwidth of the servo system, while the second signal 26 is outside the bandwidth of the servo system.

FIG. 2b shows the reduction by the servo system. The reduction is frequency dependent.

Within the bandwidth of the servo system the reduction is, in a log-log graph, a straight sloping line 22. The frequency of the first signal 21 lies within the bandwidth. By adjusting the gain of the servo system, which corresponds to a shift up or down of the straight sloping line section 22 of the reduction curve, the servo system is adjusted to obtain a desired response to the first signal 21. The horizontal line section 23 lies outside the bandwidth of the servo system and represents a reduction of essentially zero.

When the entire graph is shifted up or down the straight sloping line section 22 effectively also moves to left or right and the intersection 24 with the horizontal line section 23 of the graph, which remains at a constant level, also moves left or right. Thus the bandwidth of the servo system as indicated by the intersection 24 between the straight sloping line section 22 and the horizontal line section 23 is increased by an increase of the gain and decreased by a decrease of the gain.

FIG. 2c shows the effect of the reduction on the two signals 21, 26 of the track position modulation. The amplitude of the two resulting signals 25, 27 is affected differently. The first resulting signal 25 is affected by the reduction of the servo system as the first signal 21 lies within the bandwidth of the servo system. The servo system thus strives to greatly reduce the amplitude of the signals in it's bandwidth, i.e. to perform optimal tracking of the modulated track position. The second signal 26 however lies outside the bandwidth of the servo system, meaning that the servo system is not able to perform optimal tracking of this component of the modulation of the modulated track position. The amplitude of the second resulting signal 27 is consequently essentially not reduced by the reduction of the servo system. The second resulting signal 27 is used as a reference. By comparing the amplitude of the first resulting signal 25 to the second resulting signal 27, the gain can be properly adjusted. In addition the amplitude of the first signal 21 of the modulated track position is increased relative to the second signal 26 so that after the reduction by the servo system the amplitude of the first resulting signal 25 is increased compared to the situation in FIG. 1c. The use of the second resulting signal 27 as a reference allows the free selection of the amplitude of the first signal 21 to achieve a first resulting signal with a suitable amplitude for the servo system to work with. In FIG. 1 the amplitude of the injected signal must be fixed for the servo system to be able to calibrate its gain and bandwidth. Thus the use of two signals in the track position modulation allows more degrees of freedom for the servo system design, which is no longer limited to the single fixed amplitude of the injected signal.

Because the amplitude of the first resulting signal 25 is closer to the amplitude of the second resulting signal 27 compared to the situation in FIG. 1, the adjustment of the bandwidth of the servo system can be made more reliable.

Knowing the amplitude of the reference, the second resulting signal 27, the bandwidth is adjusted until the first resulting signal 25 reaches a desirable value, which may be an absolute value or a ratio between the first resulting signal 25 and the second resulting signal 27.

FIG. 3 shows the effect of the reduction by the servo system on track position modulation comprising two signals, both inside the bandwidth of the servo system.

FIG. 3a shows the two signals 31, 36 representing the track position modulations as present on the record carrier. The amplitude of the two signals 31, 36 is reduced by the reduction of the servo system. The reduction is a result of the control loop of the servo system which strives to achieve optimal tracking i.e. an error signal that is as small as possible. The modulation of the track position is perceived as an error signal and the control loop of the servo signal tries to suppress the modulation by adjusting the position of the optical pickup or magnetic head so that the optical pickup or magnetic head follows the track. The first signal 31 of the track modulation is within the bandwidth of the servo system at a lower frequency, while the second signal 36 is also inside the bandwidth of the servo system at a higher frequency.

FIG. 3b shows the reduction by the servo system. The reduction is frequency dependent.

Within the bandwidth of the servo system the reduction is, in a log-log graph, a straight sloping line 32.

By adjusting the gain of the servo system, which corresponds to a shift up or down of the straight sloping line section 32 of the reduction curve, the servo system is adjusted to obtain a desired response to the signals representing the track position modulation on the record carrier. The horizontal line section 33 lies outside the bandwidth of the servo system and represents a reduction of essentially zero.

When the entire graph is shifted up or down the straight sloping line section 32 effectively also moves to left or right and the intersection 34 with the horizontal line section 33 of the graph, which remains at a constant level, also moves left or right. Thus the bandwidth of the servo system as indicated by the intersection 34 between the straight sloping line section 32 and the horizontal line section 33 is increased by an increase of the gain and decreased by a decrease of the gain.

FIG. 3c shows the effect of the reduction on the two signals 31, 36 of the track position modulation. The amplitude of the two resulting signals 35, 37 is affected differently because of the different frequencies of the two resulting signal 35, 37. The first resulting signal 35 is affected by more reduction of the servo system as the first signal 31 has a lower frequency. The servo system is better at reducing the error signal at lower frequencies, i.e. is better able to track slower variations in the track position than fast variations in the track position. The second signal 36 is still within the bandwidth of the servo system, but at a higher frequency resulting in less reduction compared to the first signal 31. Because of the lower reduction of the second signal 36 because it is located in the upper section of the bandwidth of the servo system, the second resulting signal 37 can be used as a reference. By comparing the amplitude of the first resulting signal 35 to the second resulting signal 37, the gain can be properly adjusted. In addition, the amplitude of the first signal 31 of the modulated track position is increased relative to the second signal 36 so that after the reduction by the servo system the amplitude of the first resulting signal 35 is increased compared to the situation in FIG. 1c and also increased compared to the disturbances in the servo loop. The use of the second resulting signal 37 as a reference allows the free selection of the amplitude of the first signal 31 to achieve a first resulting signal with a suitable amplitude for the servo system to work with. In FIG. 1 the amplitude of the injected signal must be fixed for the servo system to be able to calibrate its gain and bandwidth. Thus the use of two signals in the track position modulation allows more degrees of freedom for the servo system design, which is no longer limited to the single fixed amplitude of the injected signal.

Because the amplitude of the first resulting signal 35 is closer to the amplitude of the second resulting signal 37 compared to the situation in FIG. 1, the adjustment of the bandwidth of the servo system can be made more reliable.

Knowing the amplitude of the reference, the second resulting signal 37, the bandwidth is adjusted until the first resulting signal 35 reaches a desirable value, which may be an absolute value or a ratio between the first resulting signal 35 and the second resulting signal 37.

FIG. 4 shows a device comprising the servo system according to the invention.

The device 41 comprises a servo system comprising a tracking error detector 44, a control unit 45 and an actuator 43.

The record carrier 40 comprises a track with a track position modulation. The record carrier is read out by a pick-up unit 42 such as a magnetic head or optical pick-up depending on the type of record carrier. Coupled to the pick-up unit 42 is an actuator 43 which controls the position of the pick-up unit 42 and allows the tracking of the track by the pick-up unit 42. A tracking error detector 44 is used to detect the error of the tracking of the pick-up unit 42 of the track on the record carrier. The tracking error detector 44 provides the control unit 45 with the first signal and second signal of FIGS. 2 and 3.

The control unit 45 processes the first and second signal and determines the correct control signal for the actuator 43 to reduce any detected tracking error. In order to adjust the bandwidth of the servo system the control unit 45 changes the gain of the servo system or adjusts the bandwidth of filters in the servo system control loop.

FIG. 5 shows a servo system with PP tracking and PP detection On the disc two signals are recorded as track position modulation w(t)=A₁ sin ω₁t+A₂ sin ω₂t where A₁ [symbol] A₂ and f₁ [symbol] f₂. By measuring the response, either the phase or the amplitude, between f1 and f2 the radial bandwidth is stabilized by altering the loop-gain.

During the explanation of FIG. 5 one should keep in mind that the subtraction device 56 is not physically present in the servo system but represents the difference between the position of the spot as controlled by the actuator and the actual track position, i.e. the tracking error. The detector 50 receives this signal and generates a tracking error signal representing this tracking error. The subtraction 56 takes place in the physical domain.

The push pull detector (PP detector) 50 derives the push pull signal from the tracking error. The push-pull signal is subsequently provided to both a detector 51 to extract the first and second resulting signal from the push-pull signal and to a loop filter 52. The detector 51 provides the first and second resulting signal to an adaptation device 53 which determines the correct loop gain in order to achieve the optimal bandwidth. The output of the adaptation device provides a multiplication factor to a multiplier 54, effectively setting the gain of the multiplier 54. The multiplier 54 receives the output of the loop filter 52, i.e. a filtered version of the error signal and provides the multiplied output of the loop filter 52 to the actuator 55.

The actuator 55 then moves in a way that the spot follows the track more accurately, effectively reducing the tracking error which is symbolized in FIG. 5 by the fact that the subtraction device 56 subtracts the position of the spot, i.e. the signal coming from the actuator 55, from the track position.

FIG. 6 shows a servo system with DPD tracking and PP detection

This embodiment shows a preferred embodiment where the tracking is performed by a DPD detector and the wobble-excursions are detected in push-pull.

At relatively low wobble-excursion amplitudes, the PP detector generates a more realistic signal. On the disc two signals are recorded as track position modulation w(t)=A₁ sin ω₁t+A₂ sin ω₂t where A₁ [symbol] A₂ and f₁ [symbol] f₂. By measuring the response, either the phase or the amplitude, between f1 and f2 the radial bandwidth is stabilized by altering the loop-gain.

During the explanation of FIG. 6 one should keep in mind that the subtraction device 66 is not physically present in the servo system but represents the difference between the position of the spot as controlled by the actuator and the actual track position, i.e. the tracking error. The detectors 60, 68 receive this signal and generate each a tracking error signal representing this tracking error.

The push-pull detector 68 generates a push-pull signal and the differential phase detector 60 generates a differential phase error signal. The push-pull signal is subsequently provided to a detector 61 to extract the first and second resulting signal from the push-pull signal. The detector 61 provides the first and second resulting signal to an adaptation device 63 which determines the correct loop gain in order to achieve the optimal bandwidth. The differential phase detector 60 provides the differential phase error signal to the loop filter 62. The output of the adaptation device 63 provides a multiplication factor to a multiplier 64, effectively setting the gain of the multiplier 64. The multiplier 64 receives the output of the loop filter 62, i.e. a filtered version of the differential phase error signal and provides the multiplied output of the loop filter 62 to the actuator 65.

The actuator 65 then moves in a way that the spot follows the track more accurately, effectively reducing the tracking error which is symbolized in FIG. 6 by the fact that the subtraction device 66 subtracts the position of the spot, i.e. the signal coming from the actuator 65, from the track position.

FIG. 7 shows a servo system with PP tracking and DPD detection Sometimes it can be advantageous to use PP tracking and use a DPD detector for reading the wobble signal.

On the disc two signals are recorded as track position modulation: w(t)=A₁ sin ω₁t+A₂ sin ω₂t where A₁ [symbol] A₂ and f₁ [symbol] f₂. By measuring the response, either the phase or the amplitude, between f1 and f2 the radial bandwidth is stabilized.

During the explanation of FIG. 7 one should keep in mind that the subtraction device 76 is not physically present in the servo system but represents the difference between the position of the spot as controlled by the actuator and the actual track position, i.e. the tracking error. The detectors 70, 78 receive this signal and generate each a tracking error signal representing this tracking error.

The differential phase detector (DPD detector) 78 generates a differential phase error signal and the push pull detector generates a push-pull signal. The differential phase error signal is subsequently provided to a detector 71 to extract the first and second resulting signal from the signal. The detector 71 provides the first and second resulting signal to an adaptation device 73, which determines the correct loop gain in order to achieve the optimal bandwidth. The push-pull detector 70 provides the push-pull signal to the loop filter 72. The output of the adaptation device 73 provides a multiplication factor to a multiplier 74, effectively setting the gain of the multiplier 74. The multiplier 74 receives the output of the loop filter 72, i.e. a filtered version of the error signal and provides the multiplied output of the loop filter 72 to the actuator 75.

The actuator 75 then moves in a way that the spot follows the track more accurately, effectively reducing the tracking error which is symbolized in FIG. 7 by the fact that the subtraction device 76 subtracts the position of the spot, i.e. the signal coming from the actuator 75, from the track position.

FIG. 8 shows a content ownership management system by varying the amplitude ratio and/or the phase relation between the wobble excursions f1 and f2 between discs (or disc types), different discs can be recognized.

This can be made clear when we assume that w(t)=A₁ sin ω₁t+A₂ sin(ω₂t+φ) is recorded as track excursion on the disc. At playback, the ratio

$$\frac{{A}_{1}}{{A}_{2}}$$

is adjusted by changing the loop-gain in order to achieve a particular radial bandwidth. By measuring φ, obviously compensated for the phase response of the servo loop, the disc can be recognized.

Alternatively, by using

$$\frac{arg ( {f}_{1} )}{arg ( {f}_{2} )}$$

or arg(f1)-arg(f2) as criteria for stabilizing the servo bandwidth if there is a harmonic relation between the frequency of the first signal and the frequency of the second signal, the ratio

$$\frac{{A}_{1}}{{A}_{2}}$$

can be used to identify discs.

In FIGS. 5, 6, 7 a servo system was shown where the f2 response is used to calibrate the DPD or PP detector gain. This is useful to measure the absolute amplitude of some hidden signals on the disc. This allows the identification of the record carrier and can thus be used as part of a content ownership management system.

This is more accurate than systems that use information stored in the modulation of the track position, i.e. wobble, to identify discs.

The device 41 comprises the same servo system as the device of FIG. 4 including the actuator 43, the tracking error detector 44 and the control unit. In FIG. 8 however the device further comprises a system controller 82 that receives information from the control unit 45 about the first signal f1 and the second signal f2 as derived from the wobble excursions. The system controller 82 can identify the discs by evaluating the ratio

$$\frac{{A}_{1}}{{A}_{2}}$$

or by measuring φ, compensated for the phase response of the servo loop. To remove the influence of the servo system on the two signals f1 and f2 derived from the wobble excursions the resulting signals as shown in FIGS. 2c and 3c are corrected for the reduction of the servo system. The identification of the discs is thus independent of the characteristics of the playback device. Identification of a disc allows the determination whether that disc is an original disc or a copied disc because during any duplication of an original disc the physical characteristics will change resulting in changes to the first signal f1 and the second signal f2. These changes are detected when evaluating the ratio

$$\frac{{A}_{1}}{{A}_{2}}$$

or by measuring φ.

To perform the content ownership management function the system controller 82 either provides the disc identification information or content control information derived from the information received from the control unit 45 to external devices that use the disc identification information or content control information to implement the content ownership management via an interface 83. Alternatively or in addition to providing the information to external devices the system controller 82 can use the information to implement the content ownership management by allowing the content decoder 81 to decode the content as derived from the record carrier 40 via the pick-up unit 42 and the signal processor 80 and to provide the decoded content to an interface 84 for further use by external devices. If the system controller 82 determines that the discs is not an original the system controller 82 prevents the content decoder 81 to decode the content and no decoded content will be provided to the interface 84 thus effectively implementing the content ownership management functionality as desired.

FIG. 9 shows a record carrier with track position modulation. The disc 40 comprises a track 90. A section 91 of the track 90 is enlarged to show two options to implement the modulation of the track position.

A first enlarged section 92 shows a track with alternating subsections 94, 95 where in the first subsection 94 the track position is modulated using a high frequency and in the second subsection 95 the track position is modulated using a low frequency. This sequence is repeated resulting in an alternation of the two modulations.

A second enlarged section 93 shows a track with a modulation of the track position where the modulation comprises two signals simultaneously. The track shown is modulated with a low frequency sine wave and a high frequency sine wave.

1. Servo system for radial tracking of an optical spot on a record carrier having an adjustable bandwidth and a device for adjusting the adjustable bandwidth by processing a first signal with a first frequency,
characterized in that the device is arranged to utilize a difference between a value representing a parameter of the first signal as derived from the record carrier and a further value representing the same parameter of a second signal with a second frequency derived from the same record carrier for adjusting the adjustable bandwidth.

2. Servo system for radial tracking of an optical spot on a record carrier as claimed in claim 1,
characterized in that the value and the further value are derived from a tracking error detector.

3. Servo system for radial tracking of an optical spot on a record carrier as claimed in claim 2,
characterized in that the first frequency is lower than the second frequency.

4. Servo system for radial tracking of an optical spot on a record carrier as claimed in claim 3
characterized in that the first signal is within the adjustable bandwidth and the second signal is outside the adjustable bandwidth of the servo system while tracking with an adjusted bandwidth.

5. Servo system for radial tracking of an optical spot on a record carrier as claimed in claim 4,
characterized in that the device for adjusting the bandwidth is arranged to adjust the bandwidth such that the further value when corrected for a first reduction by the servo system is lower than the value when corrected for a second reduction by the servo system.

6. Servo system for radial tracking of an optical spot on a record carrier as claimed in claim 5,
characterized in that the further value corrected for the first reduction by the servo system and the value when corrected for the second reduction by the servo system have a ratio within a predetermined range.

7. Servo system for radial tracking of an optical spot on a record carrier as claimed in claim 5,
characterized in that the servo system comprises retrieval means for retrieving information from the record carrier indicating the value and the further value.

8. Servo system for radial tracking of an optical spot on a record carrier as claimed in claim 1,
characterized in that the parameter is an amplitude of the signal.

9. Servo system for radial tracking of an optical spot on a record carrier as claimed in claim 1,
characterized in that the parameter is a phase of the signal.

10. Servo system for radial tracking of an optical spot on a record carrier as claimed in claim 1,
characterized in that the first signal and the second signal are signal components of a single signal

11. Servo system for radial tracking of an optical spot on a record carrier as claimed in claim 10,
characterized in that the single signal is a square wave signal.

12. Servo system for radial tracking of an optical spot on a record carrier as claimed in claim 1,
characterized in that servo system comprises a push pull detector for detecting the first signal and the second signal.

13. Servo system for radial tracking of an optical spot on a record carrier as claimed in claim 1,
characterized in that servo system comprises a differential phase detector for detecting the first signal and the second signal.

14. Servo system for radial tracking of an optical spot on a record carrier as claimed in claim 1,
characterized in that the first servo signal and the second servo signal are utilized in an alternating fashion.

15. Playback device comprising a servo system as claimed in claim 1.

16. Playback device a s claimed in claim 15, characterized in that the playback device further comprises a content ownership management device coupled to an output of the servo system and that the content ownership management device is arranged to receive information determined by the servo system based on the difference between the value and the further value.

17. Record carrier comprising a track position modulation with a first frequency and a value representing a parameter of the first signal,
characterized in that the record carrier further comprises a second track position modulation with a further value representing a parameter of the second signal where the first frequency is lower than the second frequency and where the value is different than the further value.

18. Record carrier as claimed in claim 15,
characterized in that the first track position modulation and the second track position modulation are present in an alternating fashion.

19. Record carrier as claimed in claim 17,
characterized in that the record carrier comprises a first field storing a first parameter of the first signal and a second field storing a second parameter of the second signal.
